(19) United States
(12) Patent Application Publication
(10) Pub. No.: US 2004/0006858 A1
(43) Pub. Date: Jan. 15, 2004

(54) Drive shaft assembly

(76) Inventor: Horst Klann, Villingen-Schwenningen (DE)

Correspondence Address: McGLEW AND TUTTLE, P.C., SCARBOROUGH STATION, SCARBOROUGH, NY, 10510-0827, US

(21) Appl. No.: 10/464,532

(22) Filed: Jun. 18, 2003

(30) Foreign Application Priority Data
Jul. 9, 2002 (DE) 202 10 565.2

(51) Int. Cl. B23P 19/04

(52) U.S. Cl. 29/256

(57) ABSTRACT

An assembly device (1) for drive shafts (40) having a constant-velocity joint (43) has a cross-member (19) which can be fixedly mounted on the drive shaft (40) and a support plate (5), which can be connected to the cross-member (19) via support struts (2). A tension device (32, 32/1, 36) axially supported on the outside of the support plate (5) is provided, which can be brought into engagement with a thread (55) of a drive journal (53) of the constant-velocity joint (43). For the simplest possible operation and a simple adaptation to different constant-velocity joints, it is firstly provided that the support struts (2) can be inserted into through-bores (21), running parallel to the drive shaft (40), of the cross-member (19) mounted on the drive shaft (40) and are housed axially adjustably in the through-bores (21) in relation to the cross-member. Secondly, the tension device may be formed from a tension spindle (32, 32/1), which extends axially through the support plate (5) and can be brought into fixed engagement with the thread (55) of the constant-velocity joint (43) via an assembly thread (34).

### FIELD OF THE INVENTION

The invention relates to an assembly device for drive shafts having a constant-velocity joint, consisting of a cross-member which can be mounted fixedly on the drive shaft, a support plate which can be disposed axially opposite the drive shaft with respect to the constant-velocity joint and can be connected to the cross-member via support struts extending roughly parallel to the drive shaft, wherein a tension device is provided which is axially supported on the outside of the support plate and can be brought into engagement with a thread provided on the axially outer end of a drive journal of the constant-velocity joint.

### BACKGROUND OF THE INVENTION

Mounting devices of the generic type are known, for example, from WO 01/39931 A1, which are provided to remove a constant-velocity joint from the drive shaft of a motor vehicle. Such constant-velocity joints are predominantly used in the drive systems of front-wheel drive vehicles and are seated on correspondingly peripheral toothing on the outer end of the drive shaft. Furthermore, these constant-velocity joints have a drive journal on the outside, which is also provided with peripheral toothing. This drive journal communicates, fixed in rotation, with the hub of a wheel support in the operating state.

To prevent an accidental detachment or removal of the constant-velocity joint from the drive shaft, as a rule a retaining ring is provided, which simultaneously engages in a groove or the like in the region of the toothing of the drive shaft and also of the internal toothing of the constant-velocity joint, by means of which the constant-velocity joint is seated on the peripheral toothing of the drive shaft. On account of this retaining ring, extremely high forces are required to pull the constant-velocity joint off the drive shaft.

As can be gathered in particular from WO 01/39931 A1, the constant-velocity joint is released from the drive shaft by hammer blows, amongst other things. As a result of these hammer blows, pulse-like axial forces act one the constant-velocity joint, which are a rule are necessary to prevent a “wedging” of the retaining ring in the grooves of the constant-velocity joint and of the drive shaft. This striking method has the disadvantage that, on account of the extremely restricted space on a motor vehicle in the region of the front axle, purposeful blows on the constant-velocity joint can only be carried out to a limited extent, so that frequently the entire drive shaft including the constant-velocity joint has to be dismantled for repair work. Moreover, the constant-velocity joint can become damaged with this striking method.

To be able to detach and remove a constant-velocity joint from the drive shaft in the installed state as well, in WO 01/39931 A1 an assembly device is proposed to release the constant-velocity joint from the outer end of the drive shaft, which comprises a frame-type support which consists of a cross-member which can be fixed by clamping to the drive shaft. Proceeding from this cross-member, so-called arms are to be able to be fixed to it in different axial positions. These arms have a type of support plate provided with a circular opening on their side opposite the cross-member.

In the assembled state of this assembly device on the drive shaft, the constant-velocity joint now has to extend through this opening with its end situated opposite the drive shaft. The constant-velocity joint comprises, as already mentioned above, a drive journal on the free end of which a thread is provided. In the normal operating state of the constant-velocity joint, this thread serves for fixed mounting in the hub of the wheel support of a motor vehicle. For removal the constant-velocity joint extends through the opening of the support plate with its thread, so that the normal axle nut of the vehicle for the wheel support can be screwed onto the thread of the constant-velocity joint. The two arms are fixed for example onto the retaining screws of the cross-member producing the clamping force so that the support plate is supported on the drive shaft in the axial direction via the cross-member. During the subsequent tightening of the axle nut, a tension force is thus exerted on the constant-velocity joint, by which a removal of this constant-velocity joint from the end of the drive shaft can be effected.

To be able to adapt the known device from WO 01/39931 A1 to drive shafts of different sizes, the support struts constructed as arms are provided, for example, with several through-bores lying one behind the other in the axial direction. Thus these support struts together with the support plate can be mounted in different, permanently predetermined axial positions on the drive shaft and on the cross-member.

Furthermore, it should be provided that the support struts are provided with snap-in cavities or the like, into which the clamping screws of the cross-member can be suspended in predetermined axial positions. As a result the axial adjustment may also take place without loosening the clamping screws. With this embodiment too a variable adaptation to the predetermined dimensions of a drive shaft with constant-velocity joint is only possible to a limited extent. Moreover, this construction of the known assembly device is extremely unstable when fitted to the drive shaft, so that operation is extremely difficult as the clamping screws can frequently slide out of the snap-in cavities of the support struts before the actual removal operation.

Furthermore, WO 01/39931 A1 also shows telescopically designed support struts, the axial fixing of which is again to take place via clamping screws. Moreover, for fixing to the drive shaft eccentrically mounted clamping devices are provided at the free end of the support struts close to the drive shaft, which are to apply a clamping force only during the actual clamping operation.

It has been shown in practice that the operation of this known assembly device is extremely complicated. In particular, the “suspension” of the support struts, denoted as arms, on the cross-member can only be performed painstakingly when there is restricted installation space. The adaptation to different sizes of drive shaft is only unsatisfactory, since firstly only quite specific operating positions of the support plate can be set for the provided snap-in recesses or through-bores with several positions in the support struts. As the clamping path is in turn restricted by the limited length of the thread of the drive journal, this device can only be adapted to a limited extent to different uses.

The alternative of the telescopically adjustable support struts in turn permit a variable, axial length adjustment of the support struts. However, since the mounting takes place in such a case by a single clamping screw, high axial forces can only be transmitted to a limit extent to the cross-member by means of these telescopic struts. Moreover, an adjustment of the support struts running parallel to the drive axle is only possible with difficulty, as these support struts are not automatically aligned parallel to the drive axle.

To be able to apply pulse-type axial forces as well, an impact wrench is as a rule used, in particular to release the connection by the retaining ring between the constant-velocity joint and the drive shaft. In the case of telescopic support struts this may result in an unintentional adjustment of these support struts. When using the “indexed” support struts or support struts provided with through-bores, the use of an impact wrench results in the constant-velocity joint bumping against the support plate on account of the high rotational velocity after the release of the retaining ring, in particular with shorter threads of the drive journal, as the complete length of the thread cannot be used on account of the restricted axial adjustment facility of the known assembly device. This bumping of the constant-velocity joint in turn frequently results in damage to the axle nut, the thread of the drive journal or also the constant-velocity joint itself.

### SUMMARY OF THE INVENTION

Consequently the object of the invention is to provide an assembly device which can be operated as simply as possible and which can be fitted in a simple manner to drive shafts with a constant-velocity joint of different dimensions and can be adapted to them.

Thus in accordance with the invention it is provided that the support struts can be inserted into through-bores, running parallel to the drive shaft, of the cross-member mounted on the drive shaft and are housed axially adjustably in the through-holes in relation to the cross-member.

By the embodiment according to the invention, the above-mentioned disadvantages of the known device are eliminated. For this it is provided that the support struts can be inserted into through-bores, running parallel to the drive shaft, of the cross-member. In this case the cross-member is mounted by clamping first on the drive shaft. In this mounted position the cross-member runs substantially at right angles to the drive shaft, so that its through-bores are always aligned parallel to the drive shaft. On account of this parallel alignment of the through-bores, the support struts can be mounted on the cross-member in a very simple manner by axial insertion into the through-bores, aligned parallel to the drive shaft.

The length of the support struts is constructed so that firstly the support struts can be inserted into the through-bores of the cross-member and only subsequently, for example, is the thread of the constant-velocity joint passed through the support plate. Thus an extremely simple operation of the assembly device is achieved, as the support struts can no longer slide out of the through-bores of the cross-member during the passage of the thread through the support plate.

Furthermore, in accordance with the invention these support struts are housed axially adjustably in the through bores in relation to the cross-member. This axial adjustability can take place by clamping rings or the like provided on the support struts, which are axially fixedly clamped on the support struts in the provided, variably adjustable set position as a stop. These clamping rings may also be adjusted and clamped first at a predetermined distance of the support plate from the cross-member on the support struts so that when the support struts are inserted into the through-bores, the correct operating position of the assembly device according to the invention on the drive shaft, in particular with respect to the constant-velocity joint and its drive journal, is automatically achieved. By this variable, axial adjustability of the support struts on the cross-member, the complete thread length can always be utilized, which is particularly important with shorter threads of the drive journal, so that a “bumping” of the constant-velocity joint against the support plate and thus damage is avoided as far as possible.

Alternatively to the mentioned adjustment device, in a preferred embodiment of the invention it is provided that the support struts are provided with threaded portions. With these threaded portions the support struts are axially adjustably guided in the through-bores of the cross-member. To adjust the axial distance between the cross-member and the support plate, in this embodiment adjusting nuts are provided, with which this predetermined distance can be precisely and variably adjusted in a very simple manner. In this case the setting of the adjusting nuts on the support struts may take place in advance or also afterwards, as the turning of these adjusting nuts and thus their axial position with respect to the support struts may take place manually in a very simple manner. Thus the device according to the invention can be adjusted in the simplest manner to the prevailing operating conditions. In particular, in the installed state of the drive shaft the device can be fitted onto it in a very simple manner. For this it is only necessary to fix the cross-member to the drive shaft by clamping. The following insertion of the support struts into these through-bores running parallel to the drive shaft does not require any greater skill by the operator.

In accordance with another aspect of the invention it may be provided that the adjusting nuts for accommodating the threaded portions in the through-bores of the cross-member are provided with guide bushes which can be inserted into the through-bores with slight clearance. By this embodiment an extremely precise housing of the support struts, aligned parallel to the drive shaft, in the through-bores of the cross-member is achieved. In this case slight clearance is provided between the guide bushes and the through-bores, so that a wedging of these guide bushes in the through-bores is prevented as far as possible.

Furthermore, in accordance with another aspect of the invention it may be provided that lock nuts are provided for the permanent, axial fixing of the support struts to the cross-member. After the correct adjustment of the distance from the support plate to the cross-member by appropriate adjustment of the adjusting nuts, these lock nuts are in this case screwed to the free end of the threaded portions of the support struts and brought to abut the rear of the cross-member. In this position the complete device is now correctly and fixedly attached to the drive shaft. By subsequently operating the provided tension device, a safe and simple removal of the constant-velocity joint from the drive shaft can thus also be performed in the installed state.

To be able to exert the greatest possible tensile forces on the constant-velocity joint, in accordance with another aspect of the invention it may be provided that the tension device is formed from a tension spindle which extends axially through the support plate and can be brought into fixed engagement with the thread of the constant-velocity joint via an assembly thread. This means that the tension spindle is provided with a corresponding “counter-thread” with which it can be attached in a simple manner to the thread of the drive journal of the constant-velocity joint. To apply the required tensile forces, a corresponding tension nut is provided, which can be screwed onto the outside of this tension spindle. In this case this tension nut is supported directly or indirectly on the outside of the support plate. This embodiment has in particular the advantage that to operate the tension nut impact wrenches can also be used without danger, as here the regulating distance for loosening and then removing the constant-velocity joint from the drive shaft can be chosen to be very large. By this large regulation distance, the constant-velocity joint is safely prevented from being able to bump against the support plate even with a high rotational speed of the impact wrench.

Such a use would only be possible to a limited extent with the subject matter of WO 01/39931 A1 presented in the specification preamble for the reasons already mentioned above, since there the short thread of the drive journal of the constant-velocity joint is itself used as a part of the tension device and its length cannot always be completely utilized for loosening and removal. The use of an impact wrench however has the advantage that pulse-type tension forces can also be applied to the constant-velocity joint, so that the extremely tight connection between the constant-velocity joint and the drive shaft can also be loosened in a simple manner via the retaining ring described at the beginning.

According to the another aspect of the invention features described above may also be provided independently of the configuration of the support struts. Beyond the advantages of the tension spindle which can be screwed onto the thread of the constant-velocity joint, a simple adaptation of the assembly device to the dimensions of a drive shaft with constant-velocity joint can also be performed by this combination of features. An extremely large clamping path is achieved by appropriate longitudinal design of the tension spindle. In this embodiment the support struts are only to be disposed on the cross-member in such a manner that the support plate is situated in the region of the tightening thread of the tension spindle, in which case a part of this tightening thread axially outwardly extends beyond the support plate. Now the tension nut can be placed onto the tension spindle and can be brought to directly or indirectly abut the outside of the support plate in a simple manner. Thus an adaptation, in particular to the axial length of a drive shaft with constant-velocity joint, can also be performed in a simple manner, with the adjustment of the distance between the cross-member and the support plate also being able to be adjusted in larger steps.

Furthermore, according to another aspect of the invention, an axial thrust bearing can be provided for the axial support of the tension nut. In particular, the operating forces of the tension nut with simultaneously high axial forces are considerably reduced by this axial thrust bearing.

According to another aspect of the invention it may be provided that for the direct support of the tension nut on the support plate, a pressure cylinder is provided, on which the tension nut is axially supported and through which the tension spindle axially passes. By this pressure cylinder the complete operating path is increased in the axial direction of the tension device, so that by operating the tension nut not only is a release of the snap-in connection possible via the locking ring, but the constant-velocity joint can also be removed completely from the drive shaft after loosening this snap-in connection.

According to another aspect of the invention the pressure cylinder can be exchangeably screwed with the support plate. This screw connection is in this case preferably designed so that a hydraulic cylinder acting in the pulling direction, for example, may also be used in the support plate. This hydraulic cylinder may also comprise a corresponding tension spindle, which at its free end is also provided with an assembly thread with which this tension spindle can be brought into fixed engagement with the thread of the drive journal of the constant-velocity joint. Furthermore, an adaptation to different dimensions of the seat of the constant-velocity joint on the drive shaft may take place by pressure cylinders of different lengths.

Alternatively to an embodiment noted above it may be provided that the pressure cylinder forms a one-part unit with the tension nut and that the axial thrust bearing is provided between the pressure cylinder and the support plate. The mode of operation of this embodiment is the same as with an embodiment noted above and finally the exchangeability of this unit consisting of pressure cylinder and tension nut for a hydraulic unit is dispensed with. However, by this embodiment the entire travel which can be achieved with the assembly device according to the invention is enlarged, so that a complete removal of the constant-velocity joint from the drive shaft can be safely performed.

To clamp this cross-member to the drive shaft, in accordance with another aspect of the invention this cross-member may comprise a circular arc-shaped cavity for housing the drive shaft. Associated with this cavity for clamping the drive shaft is a clamping plate which in turn comprises a circular arc-shaped recess. When clamping the drive shaft, an extremely secure support for this drive shaft on the cross-member or, on the other hand, of the cross-member on the drive shaft, is achieved by this circular arc-shaped recess or the circular-arc-shaped cavity.

For adaptation to different diameters of a drive shaft, in accordance with another aspect of the invention the cavity of the cross-member and the recess of the clamping plate may have different radii of curvature. By this embodiment or adaptation to different shaft diameters of a drive shaft, the cross-member can always be securely retained on drive shafts of different dimensions.

For the further secure mounting of the cross-member with its clamping plate on a drive shaft, in accordance with another aspect of the invention it may be provided that the cavity and/or the recess are provided with a clamping web.

In accordance with another aspect of the invention it may be provided that a support cylinder is associated with the tension spindle. By means of this support cylinder the drive journal of the constant-velocity joint can be retracted into the bearing hub of a wheel support of a motor vehicle. In this case the tension spindle together with the tension nut of the assembly device according to the invention is used. By this embodiment according to another aspect of the invention a variable use of the assembly device according to the invention is ensured. The retraction of the drive journal into the bearing hub takes place in the following steps. First of all the tension spindle is screwed onto the thread of the drive journal. Then the bearing hub of the wheel support is slid onto the outwardly protruding tension spindle, until it comes into contact by its toothing with the toothing of the drive journal. Then the support cylinder is in turn slid onto the part of the tension spindle extending beyond the bearing hub and the tension nut is screwed onto the outside of the tension spindle. By subsequent tightening of the tension nut an axial force is exerted on the bearing hub, so that it is inevitably slid onto the drive journal and the drive journal is retracted into the bearing hub.

In accordance with another aspect of the invention it may also be provided that for different axle constructions with different threads of their constant-velocity joints, various tension spindles are provided, the assembly threads of which are accordingly adapted for coupling with the thread of the constant-velocity joint or its drive journal. By the provision of different tension spindles, the assembly device according to the invention can be adapted in a very simple manner to the very different axle constructions. Thus, for example, an internal thread may be provided as an assembly thread, provided that a corresponding outer thread (threaded stem) is provided on the drive journal of the constant-velocity joint. However, as such drive journals also exist with an internal thread, it is also provided using tension spindles which are provided with a corresponding external thread which matches this.

Thus the embodiments according to the invention provide assembly devices for drive shafts with which firstly extremely high axial forces can be applied to release the connection between the constant-velocity joint and the drive shaft. Secondly, the assembly devices according to the invention can be operated in an extremely simple manner, in particular with respect to the adaptation to different dimensions of drive shafts with constant-velocity joint, and can be fixed in an extremely simple manner to a drive shaft installed in the vehicle.

The invention is explained in further detail below with reference to an exemplified embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a longitudinal sectional view of a support plate with mounted support struts and a mounted pressure cylinder;

FIG. 1a is a top view I of the part of the assembly device from FIG. 1;

FIG. 2 is an exploded partially sectional view of a cross-member constructed as a clamping device;

FIG. 3 is a sectional view III-III of a clamping plate from FIG. 2;

FIG. 4 is a sectional view IV-IV of the cross-member from FIG. 2;

FIG. 5 is a partial sectional view of a first embodiment of a tension spindle with tension nut;

FIG. 6 is a view of a second embodiment of a tension spindle;

FIG. 7 is a longitudinal sectional view through a drive axle with constant-velocity joint with cross-member fitted on the drive axle and also the tension spindle from FIG. 5;

FIG. 8 is a partial sectional view of an assembly device according to the invention which is completely fitted on the drive axle from FIG. 7;

FIG. 9 is a side view of an additional support cylinder for the retraction of the drive journal of the constant-velocity joint from FIGS. 7 and 8 in the vicinity of a wheel support; and

FIG. 10 is a partial sectional view of the start of the retraction operation of the drive journal by means of the support cylinder and also the tension spindle with tension nut from FIG. 5.

### DESCRIPTION OF THE PREFERRED EMBODIMENTS

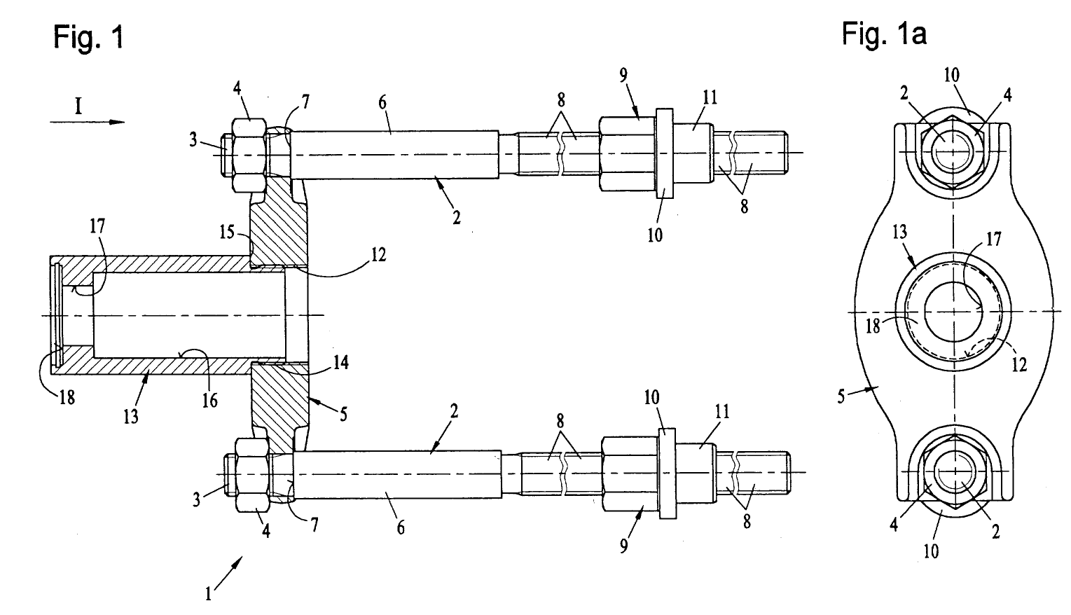

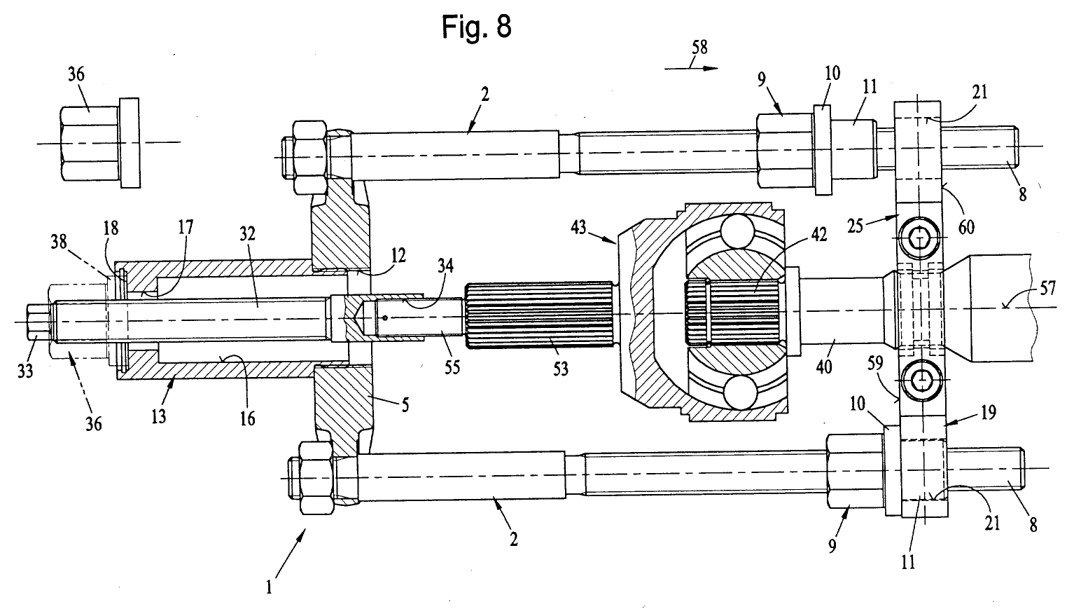

Referring to the drawings in particular, FIG. 1 shows a partial section of a part of an assembly device 1, as is completely represented in FIG. 8. As can be seen from FIG. 1, the assembly device 1 consists of two support struts 2, extending parallel to each other, which are each mounted fixed to a support plate 5 via a threaded stem 3 and a correspondingly associated fastening nut 4. Adjacent to the threaded stem 3 in each case is a radially extended shaft portion 6, which in the region of the support plate 5 forms a circumferential mounting step 7. Adjacent to this shaft portion 6, axially opposite the respective threaded stem 3, is a threaded portion 8, on which an axially adjustable adjusting nut 9 is provided in each case.

These adjusting nuts 9 are designed as so-called collar nuts and towards the free end of the thread portions 8 each have a radially extended, circumferential supporting collar 10. Immediately following this supporting collar 10 is a guide bush 11 formed in one piece on each of the adjusting nuts 9.

In the present exemplified embodiment, the support plate 5 is provided with a central through-thread 12, into which a pressure cylinder 13 is exchangeably screwed. For this the pressure cylinder 13 comprises a corresponding external thread 14. This external thread 14 is constructed tapered radially in relation to the actual pressure cylinder 13, so that the pressure cylinder 13 forms a corresponding, circumferential step 15 for the fixed mounting in the through-thread 12. Furthermore, the pressure cylinder 13 has a stepped through-bore 16, which in the region of the end opposite the external thread 14 forms a radially tapering portion 17. In the region of this radially tapering portion 17 a hollow 18 is provided on the end side in the present exemplified embodiment of the pressure cylinder 13, in which in operation a tension nut is axially supported. Between the tension nut and the hollow 18 an additional roller bearing may be provided as an axial thrust bearing, which is housed in the hollow 18 (not shown in the drawings).

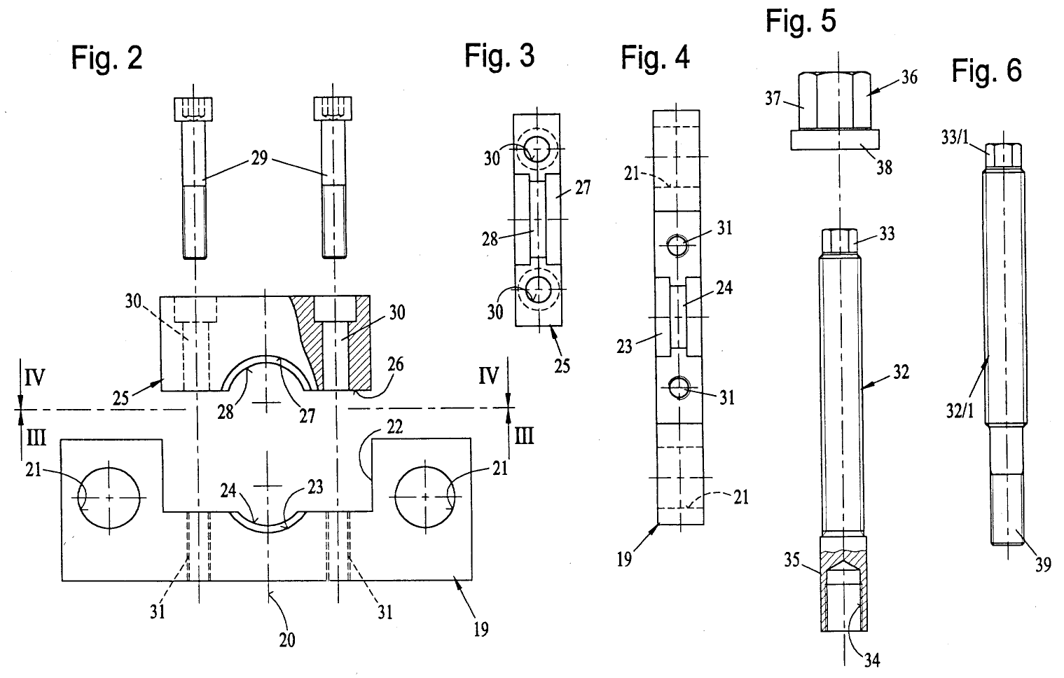

Furthermore, the assembly device according to the invention consists of a cross-member 19 represented in FIG. 2. In the present exemplified embodiment this cross-member 19 has a roughly U-shaped construction and comprises through-bores 21 symmetrically with respect to its axis of symmetry 20 in its lateral end regions. Between these through-bores 21 is situated a U-shaped recess 22, which is also disposed symmetrically to the axis of symmetry 20. In the center this recess 22 is provided with a circular arc-shaped cavity 23 with clamping web 24, as can be seen in particular also from FIG. 4.

Associated with the U-shaped recess 22 is a clamping plate 25, which in the assembled state in its end side 26 facing the recess 22 comprises an arc-shaped recess 27. This arc-shaped cavity 27 also has a central clamping web 27. Both the cavity 23 and the recess 27 serve to clamp the cross-member 19 to a drive shaft of a motor vehicle.

Two clamping screws 29 constructed as inner hexagon screws are provided for the purpose of this clamping mounting. These clamping screws 29 can accordingly be inserted through through-bores 30 and be screwed into corresponding threaded bores 31 of the cross-member 19. To achieve a uniform clamping force, both the through-bores 30 of the clamping plate 25 and the threaded bores 31 of the cross-member 19 are disposed symmetrically to the axis of symmetry 20 of the cross-member 19.

FIG. 5 shows a first exemplified embodiment of a tension spindle 32. In FIG. 5 a drive hexagon 33 is provided at the upper end of this tension spindle 32. Opposite this drive hexagon 33, the tension spindle 32 has an assembly thread 34 constructed as an internal thread 34. In the region of this assembly thread 34 the tension spindle 32 in the present exemplified embodiment has a radially widened construction and forms a cylindrical retaining shaft 35. Associated with this tension spindle 32 is a tension nut 36, which comprises a drive hexagon 37 and also a circumferential, radially enlarged collar 38.

FIG. 6 shows a second exemplified embodiment of a tension spindle 32/1, which also at the upper end is provided with a drive hexagon 33/1. In its end region axially-opposite this drive hexagon 33/1, the tension spindle 32/1 is provided with a threaded stem 39 which has a radially tapering construction.

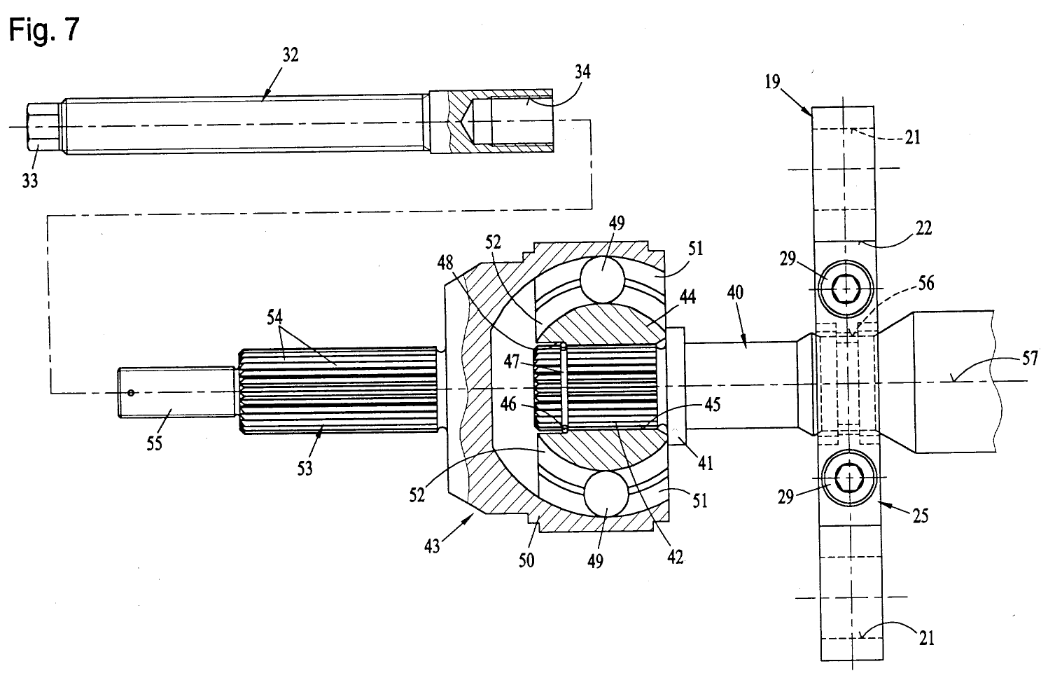

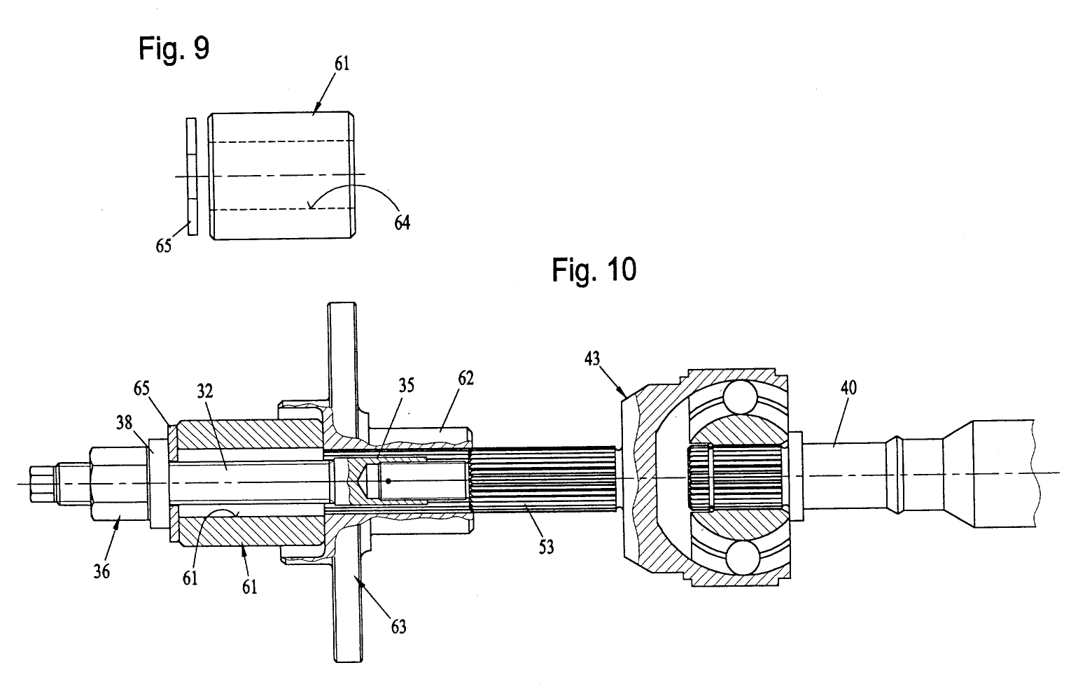

These two embodiments of the tension spindles 32 and 32/1, which are shown by way of example, serve to remove differently constructed constant-velocity joints, as already stated in the specification preamble and as described below with respect to FIGS. 7 and 9 for the tension spindle 32 from FIG. 5.

FIG. 7 shows a drive shaft 40, which at its outside end is provided with a stop collar 41 and also a toothing portion 42. A so-called constant-velocity joint 43 is fitted onto this toothing portion 42. This constant-velocity joint 43 comprises an inner bearing member 44, which with corresponding internal toothing 45 is fitted fixed in rotation onto the toothing portion 42 of the drive shaft 40. To secure the operating position represented in FIG. 7 of the constant-velocity joint 43 on the toothing portion 42, a retaining ring 46 is provided, which in this assembled state engages simultaneously in a peripheral groove 47 of the toothing portion 42 and also in a circumferential shoulder 48 of the inner bearing member 44.

A bearing housing 50 is housed, via corresponding ball bearings 49, on this internal bearing member in an axially non-displaceable manner, but being able to swivel relative to the drive shaft 40, via corresponding arc-shaped, axial grooves 51 and 51 of the bearing housing 50 and of the inner bearing member 44. In the region of its axial outer end, the bearing housing 50 is provided with a drive journal 53, which at its outer periphery comprises so-called splined shaft toothing 54, for example.

In the present exemplified embodiment of the constant-velocity joint 43, the drive journal 53 has an axially protruding thread 55 on its outer end, which is constructed as a threaded stem.

In the normal operating state, the drive journal 53 engages with its splined shaft toothing 54 in corresponding internal toothing of a hub of a wheel support. This hub and the wheel support are fixedly attached to the drive journal 53 via a corresponding locking nut that can be screwed onto the thread 55, as is sufficiently known from the prior art.

The assembly device 1 according to the invention is now provided for the removal or for the dismantling of the complete constant-velocity joint 43 from the drive shaft 40.

For this firstly the cross-member 19 is fixed to a corresponding, e.g. radially tapered portion 56 of the drive shaft 40. For this the cross-member 19 is attached by the clamping web 24 of its cavity 23 in the region of portion 56 of the drive shaft 40. Then the clamping plate 25 is inserted into the U-shaped recess 22 of the cross-member 19 and is fixed in this recess 22 by means of the clamping screws 19. At the same time the circular arc-shaped recess 27 with its clamping web 28 brings about, in conjunction with the clamping web 24 of the circular arc-shaped cavity 23 of the cross-member 19, a fixed mounting of the cross-member 19 by clamping to the drive shaft 40 as represented in FIG. 7.

As can also be seen from FIG. 7, the cross-member 19 is constructed in its “width” in such a manner that the two through-bores 21 both lie symmetrically to the longitudinal center axis 57 of the drive shaft 40 and radially outside the constant-velocity joint 43 and its bearing housing 50. In the next operating step for the removal of the constant-velocity joint 43, the tension spindle 32 also shown in FIG. 7 is now screwed by its assembly thread 34 onto the thread 55 of the constant-velocity joint 43. To prevent accidental loosening during subsequent removal, this tension spindle 32 may be tightened via its drive hexagon 33 on the thread 55 of the constant-velocity joint 43.

FIG. 8 shows the assembly device 1 completely fitted to the drive shaft 40 with its constant-velocity joint 43.

From FIG. 8 it can be seen that the tension spindle 32 with its assembly thread 34 is fixedly screwed onto the thread 55 of the drive journal 53. The two support struts 2 are inserted by their threaded portions 8 into the respective associated through-bore 21 of the cross-member 19 mounted fixedly on the drive shaft 40. At the same time the tension spindle 32 is passed through the through-thread 12 and also the through-bore 16 by its radially tapering portion 17 of the pressure cylinder 13. In this working position of the assembly device 1 shown in FIG. 8, the tension spindle 32 with its drive hexagon 33 and also this axially adjacent threaded portion extends outwardly through the pressure cylinder 13 in the axial direction. In this position the tension nut 36 also shown in FIG. 8 can be screwed onto the tension spindle 32 and is brought into the initial position shown by phantom lines. In this initial position the tension nut 36 is supported by its collar 38 in the hollow 18 of the pressure cylinder 13.

After screwing the tension nut 36 onto the tension spindle 32, the two adjusting nuts 9 can now be advanced in the direction of arrow 58 to align the entire assembly device 1 in the direction of the cross-member 19. In FIG. 8 the upper adjusting screw 9 is represented still in its (arbitrary) initial position, while the lower adjusting screw 9 is already situated in its end position. In this end position the adjusting nut 9 lies with its supporting collar 10 “loosely” on the outer face 59 of the cross-member 19. At the same time the adjusting nut 9 with its guide bush 11 engages with slight clearance into the correspondingly associated through-bore 21 of the cross-member 19. Thus by appropriate axial adjustment of the two adjusting nuts 9 along the two threaded portions 8 of the support struts 2, the assembly device 1 can be aligned in a simple manner parallel to the longitudinal center axis 57 of the drive shaft 40. To be able to fix the two support struts 2 seated in this operating position on the cross-member 19, two lock nuts may also be provided, which can be screwed onto the free end of the threaded portions 8 of the support struts 2 and can be brought to abut the rear outer face 60 of the cross-member 19. These lock nuts are not represented in FIG. 8.

It can be seen that the assembly device according to the invention with its cross-member 19, the two support struts 2 and also the support plate 5 together with the tension spindle 32 and the tension nut 36 can be fitted in a very simple manner on a drive shaft 40 with its constant-velocity joint 43. The adaptation of the assembly device 1 according to the invention to different lengths of drive shafts with constant-velocity joint can also be performed by corresponding axial adjustment of the adjusting nuts 9 along the threaded portions 8 of the support struts 2.

On account of the greater length of the tension spindle 32, with the assembly device according to the invention not only can a loosening of the constant-velocity joint 43 from the toothing portion 42 be performed, but the constant-velocity joint 43 can be completely removed from this toothing portion 42, by which on account of the greater length of the tension spindle 32 an adaptation to the length of the drive shaft 40 with its constant-velocity joint 43 can also additionally take place in a very simple manner. As it is simple to insert the two support struts 2 into the through-bores 21 running parallel to the longitudinal center axis 57 of the drive shaft 40, an extremely simple manipulation is also achieved, in particular in the still installed state of the drive shaft 40 in the motor vehicle.

Furthermore, the use of a tension spindle 32, possibly in conjunction with an additional support cylinder 61, also permits the retraction of the drive journal 53 into the hub 62 of a wheel support 63, as is represented in FIGS. 9 and 10. For this the support cylinder 61 comprises a through-bore 64 which is designed with a corresponding diameter and which is adapted to the diameter of the retaining shaft 35 of the tension spindle 32 in such a manner that this retaining shaft 35 can be completely pulled through the through-bore 64. A corresponding flat washer 65 may also be provided to support the tension nut 36 represented in FIG. 10 on the support cylinder 61.

From FIG. 10 it can be easily conceived that by tightening the tension nut 36, the drive journal 53 of the constant-velocity joint 43 is retracted into the hub 62 of the wheel support 63 or respectively this hub 62 can be pushed onto the drive journal 53. This means that after the drive axle has been repaired and the constant-velocity joint 42 is again fitted onto the drive axle, the subsequent operation, namely the retraction of the drive journal 53 into the wheel support 63 or its hub 62, can be performed in a simple manner by using the same tension spindle 32 with its tension nut 36. An additional or further tool is thus no longer necessary when using the assembly device 1 according to the invention. In this case it can also be conceived that, instead of an additional support cylinder 61, as is represented in FIG. 9, the pressure cylinder from FIG. 1 can be appropriately configured so that it can also be used for the retraction of the drive journal 53 into the hub 62 of the wheel support 63.

While specific embodiments of the invention have been shown and described in detail to illustrate the application of the principles of the invention, it will be understood that the invention may be embodied otherwise without departing from such principles.

What is claimed is:

1. An assembly device for drive shafts having a constant-velocity joint, the assembly device comprising:
a cross-member which can be fixedly mounted on the drive shaft;
support struts;
a support plate which can be disposed axially opposite the drive shaft with respect to the constant-velocity joint and which can be connected to the cross-member via said support struts running roughly parallel to the drive shaft; and
a tension device axially supported on the outside of the support plate said tension device being brought into engagement with a thread disposed on the axially outer end of a drive journal of the constant-velocity joint, wherein the support struts can be inserted into through-bores, running parallel to the drive shaft, of the cross-member mounted on the drive shaft and are housed axially adjustably in the through-bores in relation to the cross-member.

2. An assembly device according to claim 1, wherein the support struts are provided with threaded portions with which the support struts are axially adjustably guided in the through-bores of the cross-member and adjusting nuts are provided for the adjustment of the axial distance between the cross-member and the support plate.

3. An assembly device according to claim 2, wherein the adjusting nuts for accommodating the threaded portions in the through-bores of the cross-member are provided with guide bushes which can be inserted into the through-bores with slight clearance.

4. An assembly device according to claim 1, further comprising:
lock nuts provided for the permanent axial fixing of the support struts to the cross-member.

5. An assembly device according to claim 1, further comprising:
a tension nut wherein the tension device is formed from a tension spindle extending axially through the support plate and which can be brought into fixed engagement with the thread of the constant-velocity joint via an assembly thread and said tension nut is screwed onto the tension spindle and is supported directly or indirectly on the support plate.

6. An assembly device for drive shafts having a constant-velocity joint, the assembly device comprising:
a cross-member fixedly mounted on the drive shaft;
support struts;
a support plate which can be disposed axially opposite the drive shaft with respect to the constant-velocity joint and which can be connected to the cross-member via said support struts running roughly parallel to the drive shaft;
a tension device which is axially supported on the outside of the support plate and can be brought into engagement with a thread disposed on the axially outer end of a drive journal of the constant-velocity joint, said tension device being formed from a tension spindle which extends axially through the support plate and can be brought into a fixed engagement with the thread of the constant-velocity joint via an assembly thread; and
a tension nut provided to be screwed onto the tension spindle, said tension nut being directly or indirectly supported on said support plate.

7. An assembly device according to claim 5, wherein an axial thrust bearing is provided for the axial support of the tension nut.

8. An assembly device according to claim 5, wherein for the direct support of the tension nut on the support plate a pressure cylinder is provided, on which the tension nut is axially supported and through which the tension spindle axially passes.

9. An assembly device according to claim 8, wherein the pressure cylinder is exchangeably screwed with the support plate.

10. An assembly device according to claim 8, wherein the pressure cylinder with the tension nut forms a single-part unit and the axial thrust bearing is provided between the pressure cylinder and the support plate.

11. An assembly device according to claim 1, wherein the cross-member for housing the drive shaft comprises a circular arc-shaped cavity for clamping the drive shaft, said cavity being associated with a clamping plate which comprises a circular arc-shaped recess.

12. An assembly device according to claim 11, wherein the cavity of the cross-member and the recess of the clamping plate have different radii of curvature.

13. An assembly device according to claim 11, wherein the cavity and/or the recess is or are provided with a clamping web.

14. An assembly device according to claim 5, wherein associated with the tension spindle is a support cylinder by means of which the drive journal of the constant-velocity joint can be retracted into the hub of a wheel support of a motor vehicle axle in conjunction with the tension spindle and the tension nut.

15. An assembly device according to claim 5, wherein for different axle constructions with different threads of their constant-velocity joints, various tension spindles having correspondingly adapted assembly threads are provided for coupling with the thread of the constant-velocity joint.
